(19) United States
(12) Patent Application Publication
(10) Pub. No.: US 2018/0113325 A1
(43) Pub. Date: Apr. 26, 2018

(54) EYE CONTACT LENS AND METHOD FOR MANUFACTURING SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/485,398

(22) Filed: Apr. 12, 2017

(30) Foreign Application Priority Data
Oct. 24, 2016 (TW) 105134341

(51) Int. Cl. G02C 7/04; B29D 11/00

(52) U.S. Cl. CPC G02C 7/049; B29D 11/00067; B29D 11/00115; B29K 2105/0097; B29D 11/00192; B29D 11/0048; G02C 2202/16; B29D 11/00134

(57) ABSTRACT

An eye contact lens includes a main body and a water locking structure. The main body includes a front surface, a rear surface and an annular side surface connecting the front surface and the rear surface, the front surface and the rear surface were substantially spherical surfaces. The water locking structure includes a plurality of water locking sheets. The plurality of water locking sheets in the main body being sequentially stacked, and forms many water locking layers, each water locking layer comprises a plurality of parallel rows, each row comprises a plurality of single water locking sheet arranging apart.

The subject matter herein generally relates to eye contact lens and a method for manufacturing thereof.

### BACKGROUND

For poor eyesight, people often need to wear prescription glasses or contact lenses to see clearly. Contact lenses are convenient. However, eyes will feel dry when contact lenses are worn for a long time, and a red-eye phenomenon is caused.

### BRIEF DESCRIPTION OF THE DRAWINGS

Implementations of the present technology will now be described, by way of example only, with reference to the attached figures.

FIG. 1 is an isometric view of an eye contact lens in accordance with an exemplary first embodiment.

FIG. 2 is a cross section view along line II-II of FIG. 1.

FIG. 3 is a cross section view along line III-III of FIG. 1.

FIG. 4 is an enlarged view of circled area IV-IV of FIG. 3.

FIG. 5 is a flowchart of a method for manufacturing the eye contact lens of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series, and the like. The references “a plurality of” and “a number of” mean “at least two.”

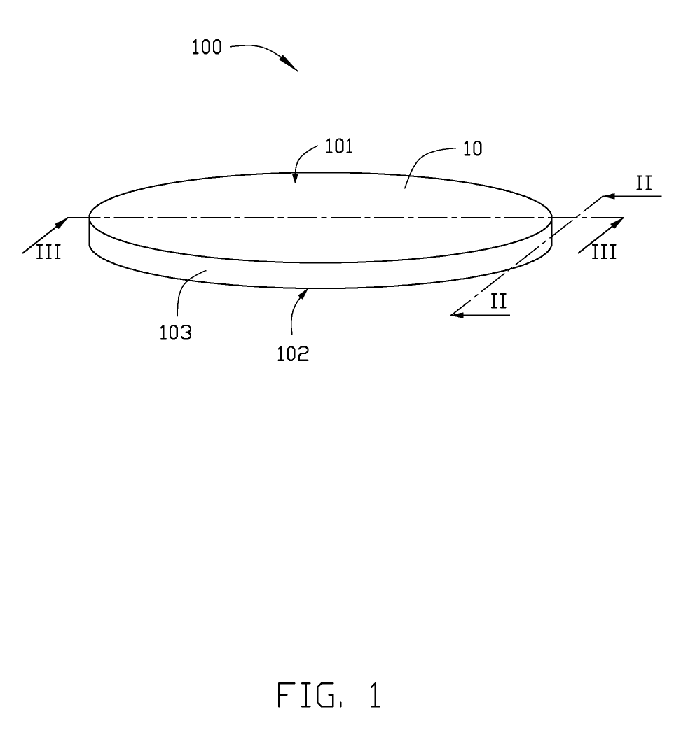

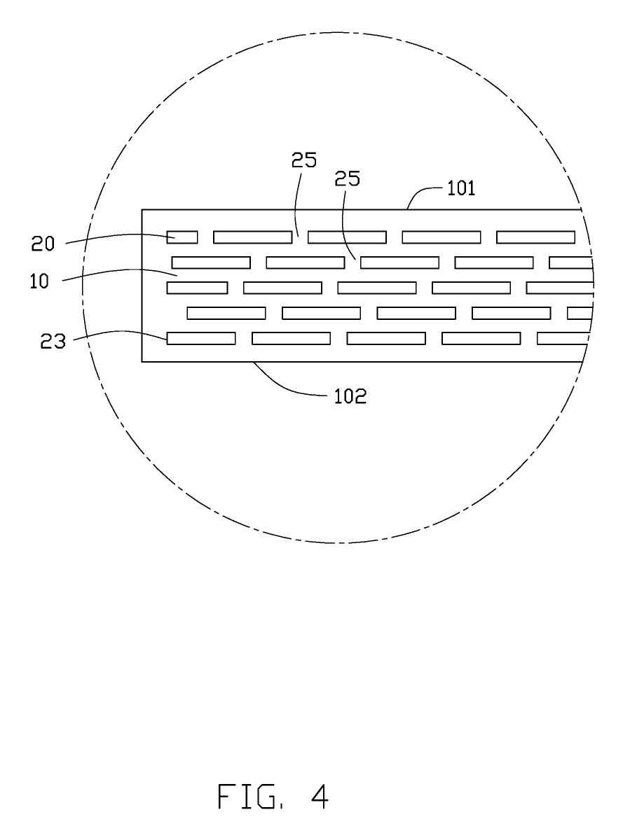

FIGS. 1-4 illustrate an eye contact lens 100 according to a first exemplary embodiment. The eye contact lens 100 includes a main body 10 and a water locking structure 20 formed in the main body 10.

The main body 10 is made from silica gel or hydrogel. A thickness of the main body 10 is in a range from about 0.003 to about 0.1 millimeter. The main body 10 is transparent and comprises a front surface 101, a rear surface 102, and an annular side surface connecting the front surface 101 and the rear surface 102. The front surface 101 and the rear surface 103 are substantially spherical surfaces and match with curved shape of human eye. That is, when the contact lenses 100 are worn, the rear surface 102 or the front surface 101 are configured to be in full contact with eyes of a wearer.

The water locking structure 20 is also substantially transparent. The water locking structure 20 includes a plurality of water locking sheets 22 and the water locking sheets 22 are distributed regularly in the main body 10. In the illustrated embodiment, the water locking sheets 22 are made from clay and the clay is aluminum silicate (Montmorillonite). A length of the water locking sheet 22 is about 1 um, and a thickness of the water locking sheet 22 is about 9.6 nm. In an alternative embodiment, the water locking sheet 22 is made from silicon magnesium acid aluminum (Laponite), a length of the water locking sheet 22 is about 1 nm, and a thickness of the water locking sheet 22 is about 23˜27 nm.

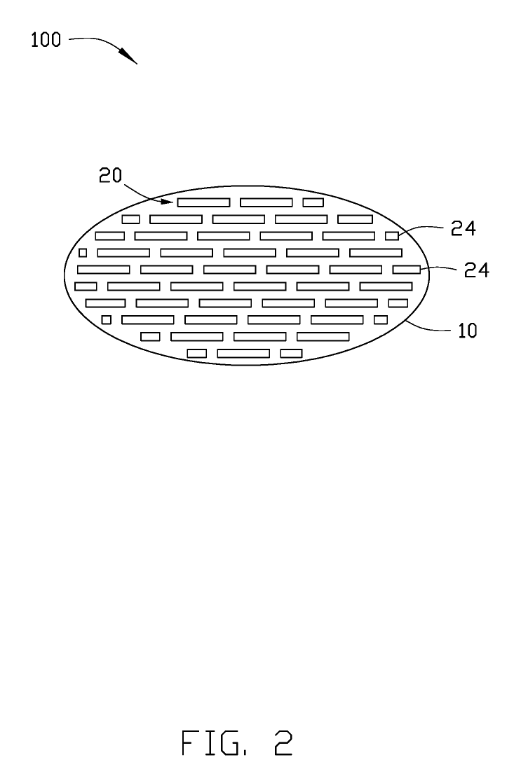

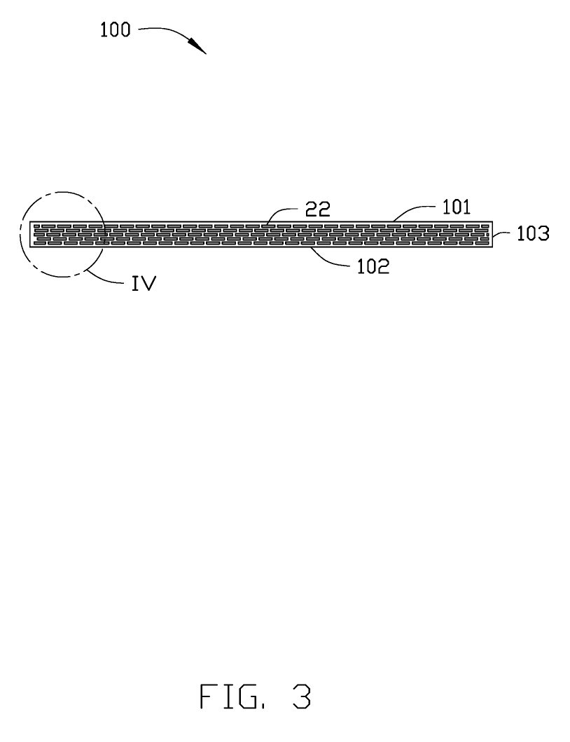

FIG. 2 is a cross section view along a plane parallel to the front surface 101, and FIG. 3 is a cross section view along a thickness direction of the eye contact lens 100. As shown in FIG. 3, the water locking sheets 22 in the main body 10 are sequentially stacked, and form multiple water locking layers 23. As shown in FIG. 2, each water locking layer 23 includes a plurality of parallel rows 24. Each row 24 includes a plurality of single water locking sheets 22. Each two adjacent single water locking sheets 22 in a same row forms a passage 25.

Passages 25 in one row of one water locking layer 23 are staggered in relation to a corresponding passages 25 in a row of an adjacent water locking layer 23. Thereby, the plurality of water locking sheets 22 provides an effective barrier to the passage of water evaporation, and this is beneficial for slowing the water evaporation, so that the eye contact lens 100 is able to keep moist for a longer time.

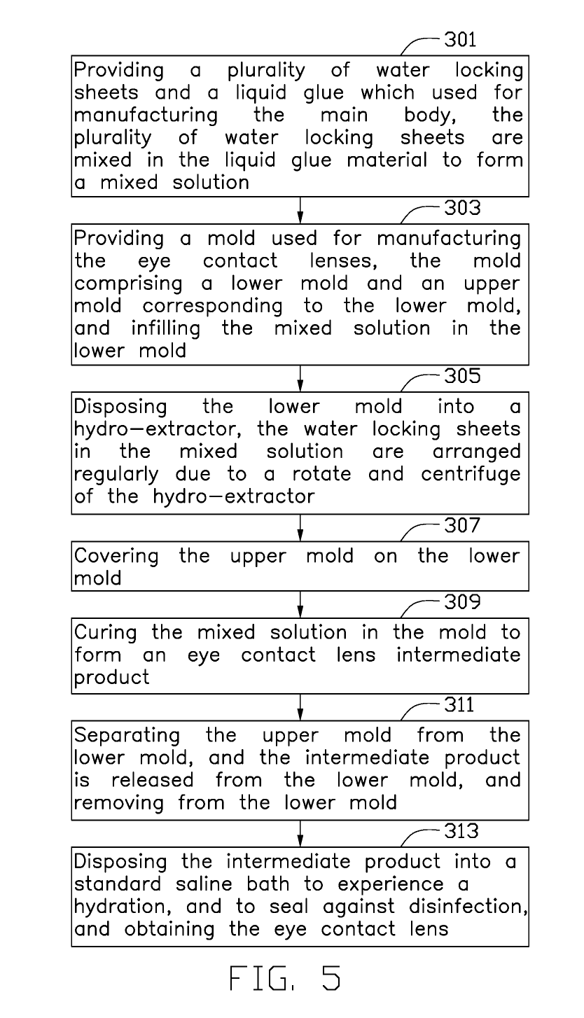

FIG. 5 illustrates a flowchart in accordance with a second embodiment. The example method 300 for manufacturing the eye contact lens 100 (shown in FIG. 1) is provided by way of an example, as there are a variety of ways to carry out the method. Additionally, the illustrated order of blocks is by example only and the order of the blocks can change or be omitted. The method 300 can begin at block 301.

At block 301, as shown in FIG. 5, a plurality of water locking sheets 22 and a liquid glue used for manufacturing the main body 10 are provided.

The plurality of water locking sheets 20 are made from transparent clay. The plurality of water locking sheets 20 are mixed in the liquid glue material to form a solution, a weight of the sheet body 20 in the liquid glue material is less than 30%. The liquid glue is selected from hydrogel or silicone hydrogel. The liquid glue contains a hydrophilic monomer, such as initiator and crosslinking agent. If the liquid glue is hydrogel, the hydrophilic monomer in the liquid glue is one selected from this group of hydroxyl ethyl methacrylate (HEMA), methacrylic acid methyl methacrylate (MAA), N-two methyl acetamide (DMA), and vinyl pyrrolidone (NVP). If the liquid glue is silicone hydrogel, the hydrophilic monomer in the liquid glue is one selected from this group of three parts methyl alkoxy silicon (TRIS) and two parts polymethyl siloxane (PDMS).

At block 303, as shown in FIG. 3, a mold (not shown) for manufacturing the eye contact lenses 100 is provided. The mold includes a lower mold and an upper mold. The solution is input into the lower mold.

At block 305, the lower mold filled with the solution is disposed into a hydro-extractor, the water locking sheets 20 in the mixed solution are rotated and centrifuged by the hydro-extractor. Water locking sheets 20 are regularly distributed in the solution, and the water locking sheets 20 are covered completely by the liquid glue. Each row includes a plurality of water locking sheets 20, each two adjacent water locking sheets 20 in a same row forms a passage 22, the passages 22 being staggered. In the illustrated embodiment, centrifuge speed ranges from about 500˜about 10000 revolutions per minute.

At block 307, the upper mold is placed on the lower mold.

At block 309, the mold is disposed into an oven, or disposed below a UV lamp. The solution in the mold is cured to form an eye contact lens intermediate product, and a thickness of the intermediate product is about about 0.003- about 0.1 mm. A temperature for a thermal curing oven ranges from about 90 degree to about 125 degree, the time for a thermal curing is about 5 min˜about 30 min, and a UV light curing strength is about 3000 uw/cm²˜about 5000 uw/cm². The curing time is about 1 min˜about 15 min.

At block 311, the upper mold is separated from the lower mold, and the intermediate product is removed from the lower mold.

At block 313, the intermediate product is disposed into a standard saline bath to experience hydration, and to seal against infection. The eye contact lens 100 is thus obtained.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An eye contact lens, comprising:
a main body, the main body comprises a front surface, a rear surface and an annular side surface connecting the front surface and the rear surface, the front surface and the rear surface were substantially spherical surfaces; and
a water locking structure, the water locking structure comprising a plurality of water locking sheets, the plurality of water locking sheets in the main body being sequentially stacked, and forms multiple water locking layers, each water locking layer comprises a plurality of parallel rows, each row comprises a plurality of single water locking sheet arranging part.

2. The eye contact lens of claim 1, wherein each two adjacent single water locking sheet in a same row forms a passage, passages in one row of one water locking layer are staggered in relation to a corresponding passages in a row of an adjacent water locking layer.

3. The eye contact lens of claim 1, wherein the water locking structure is substantially transparent and made from clay.

4. The eye contact lens of claim 3, wherein the clay is aluminum silicate.

5. The eye contact lens of claim 4, wherein a length of the water locking sheet is about 1 um, and a thickness of the water locking sheet is about 9.6 nm.

6. The eye contact lens of claim 3, wherein the clay is silicon magnesium acid aluminum.

7. The eye contact lens of claim 6, wherein a length of the water locking sheet is about 1 nm, a thickness of the water locking sheet is about 23˜about 27 nm.

8. The eye contact lens of claim 1, wherein the main body is made from silica gel.

9. The eye contact lens of claim 1, wherein the main body is made from or hydrogel.

10. A method for manufacturing an eye contact lens, comprising:
providing a plurality of water locking sheets and a liquid glue which used for manufacturing the main body, the plurality of water locking sheets are mixed in the liquid glue material to form a solution;
providing a mold used for manufacturing the eye contact lenses, the mold comprising a lower mold and an upper mold corresponding to the lower mold, and infilling the solution in the lower mold;
disposing the lower mold into a hydro-extractor, the water locking sheets in the solution are distributed regularly due to a rotate and centrifuge of the hydro-extractor;
placing the upper mold on the lower mold;
curing the solution in the mold to form an eye contact lens intermediate product;
separating the upper mold from the lower mold, and the intermediate product is released from the lower mold, and removing from the lower mold; and
disposing the intermediate product into a standard saline bath to experience a hydration, and to seal against disinfection, and obtaining the eye contact lens.

11. The method of claim 10, wherein the water locking sheet is substantially transparent and made from clay.

12. The method of claim 11, wherein the clay is aluminum silicate.

13. The method of claim 13, wherein a length of the water locking sheet is about 1 um, and a thickness of the water locking sheet is about about 9.6 nm.

14. The method of claim 11, wherein the clay is silicon magnesium acid aluminum.

15. The method of claim 14, wherein a length of the water locking sheet is about 1 nm, a thickness of the water locking sheet is about 23˜about 27 nm.

16. The method of claim 10, wherein a temperature for a thermal curing is ranged from about 90 degree to about 125 degree, the time for a thermal curing is about 5 min˜about 30 min, and the light curing strength is about 3000 uw/cm²˜about 5000 uw/cm², and the curing time is about 1 min˜about 15 min.

17. The method of claim 10, wherein the centrifuge speed is ranged from about 500˜about 10000 revolutions per minute.

18. An eye contact lens, comprising:
a lens main body, and a water locking structure formed in the lens main body, the water locking structure comprising a plurality of water locking sheets, the plurality of water locking sheets in the main body being sequentially stacked to form a barrier to the passage of water evaporation.

19. The eye contact lens of claim 18, wherein the sequentially stacked water locking sheets form many water locking layers, each water locking layer comprises a plurality of parallel rows, each row comprises a plurality of single water locking sheets arranged apart, each two adjacent single water locking sheets in a same row forms a passage, the front of each passage is distributed a single water locking sheet.

20. The eye contact lens of claim 18, wherein the water locking sheet is transparent.
